(19) United States
(12) Patent Application Publication
(10) Pub. No.: US 2016/0332874 A1
(43) Pub. Date: Nov. 17, 2016

(54) METHOD FOR CARBON DIOXIDE HYDROGENATION OF SYNGAS

(71) Applicant: SAUDI BASIC INDUSTRIES CORPORATION, Riyadh (SA)

(72) Inventor: Aghaddin Mamedov, Sugar Land, TX (US)

(21) Appl. No.: 15/109,725

(22) PCT Filed: Jan. 6, 2015
(86) PCT No.: PCT/US15/10282

§ 371 Date: Jul. 5, 2016

Related U.S. Application Data
(60) Provisional application No. 61/923,950, filed on Jan. 6, 2014.

(51) Int. Cl. C01B 3/40; B01J 23/883

(52) U.S. Cl. CPC C01B 3/40; B01J 23/883; C01B 2203/0238; C01B 2203/1088; C01B 2203/1052; C01B 2203/1241

(57) ABSTRACT

Processes for making a syngas mixture including hydrogen, carbon monoxide, and carbon dioxide are provided. In an exemplary embodiment, the processes include contacting a gaseous feed mixture that includes carbon dioxide, hydrogen and methane with a metal oxide catalyst that includes molybdenum and nickel. Catalysts for making a syngas mixture, including molybdenum and nickel are also provided.

### FIELD

The presently disclosed subject matter relates to processes and catalysts for making a syngas mixture.

### BACKGROUND

Syngas is a gaseous mixture containing hydrogen (H₂) and carbon monoxide (CO), which may further contain other gas components, e.g., carbon dioxide (CO₂), water (H₂O), methane (CH₄), and/or nitrogen (N₂). Natural gas and light hydrocarbons are the predominant starting materials for making syngas. Syngas is used as synthetic fuel and also in a number of chemical processes, such as synthesis of methanol, ammonia, Fischer-Tropsch type synthesis, and other olefin syntheses, hydroformylation or carbonylation reactions, reduction of iron oxides in steel production, etc.

Such syngas processes frequently use methane as a starting material, which may be converted to syngas by steam reforming, partial oxidation, CO₂ reforming, or by a so-called auto-thermal reforming reaction. However, a drawback of producing syngas by steam reforming of methane is the reaction stoichiometry, which can lead to H₂/CO ratios of 3 or higher.

In order to avoid such drawbacks and to help counteract increasing CO₂ concentrations in the atmosphere, attempts have been made to manufacture syngas from CO₂ as a raw material. The conversion is based on the following equilibrium reaction:

CO+H₂O [symbol] CO₂+H₂

The forward reaction is known as the water gas shift (WGS) reaction, while the reverse reaction is known as the reverse water gas shift (RWGS) reaction.

Conversion of CO₂ to CO by a catalytic RWGS reaction can be useful for CO₂ utilization. Early work proposed iron oxide/chromium oxide (chromite) catalysts for this endothermic reaction; see, e.g., U.S. Pat. No. 1,913,364. However, these catalysts can suffer from methane formation and an accompanying catalyst coking problem.

GB 2168718A discloses combining the RWGS reaction with steam reforming of methane. The combination of the two reactions allowed the molar ratio of H₂ to CO (H₂/CO) to be adjusted and to better control the stoichiometric number (SN) given by ([H₂]—[CO₂])/([CO]—[CO₂]) in the final syngas mixture to values of about 3 or higher, depending on the intended subsequent use of the syngas mixture.

GB 2279583A discloses a catalyst for the reduction of carbon dioxide, which comprised at least one transition metal selected from Group VIII metals and Group VIa metals supported on ZnO alone, or on a composite support material containing ZnO. In order to suppress methane formation and catalyst deactivation, stoichiometric hydrogen/carbon dioxide mixtures and low reaction temperatures were used, which resulted in relatively low carbon dioxide conversion.

U.S. Pat. No. 5,346,679 discloses the reduction of CO₂ into CO with H₂ using a catalyst based on tungsten sulphide. U.S. Pat. No. 3,479,149 discloses using crystalline aluminosilicates as catalyst in the conversion of CO and water to CO₂ and H₂, and vice versa.

U.S. Pat. No. 5,496,530 discloses CO₂ hydrogenation to syngas in the presence of nickel and iron oxide and copper or zinc containing catalysts. In WO 96/06064A1, a process for methanol production is described, which includes converting part of the CO₂ contained in a feed mixture with H₂ to CO, in the presence of a WGS catalyst exemplified by Zn—Cr/alumina and MoO₃/alumina catalysts.

WO 2005/026093A1 discloses a process for producing dimethylether (DME), which includes a step of reacting CO₂ with H₂ in a RWGS reactor to provide carbon monoxide, in the presence of a ZnO supported catalyst; a MnOₓ (=1˜2) supported catalyst; an alkaline earth metal oxide supported catalyst and a NiO supported catalyst. EP 1445232A2 discloses a RWGS reaction for production of CO by hydrogenation of CO₂ at high temperatures, in the presence of a Mn—Zr oxide catalyst.

United States Patent Publication No. 2003/0113244A1 discloses a process for the production of a synthesis gas (syngas) mixture that is rich in carbon monoxide, by converting a gas phase mixture of CO₂ and H₂ in the presence of a catalyst based on zinc oxide and chromium oxide, but not including iron. The presence of both Zn and Cr was indicated to be essential for formation of CO and H₂ mixture at a good reaction rate, whereas the presence of Fe and/or Ni is to be avoided to suppress formation of CH₄ via so-called methanation side-reactions. Formation of CH₄ as a by-product is generally not desired, because its production reduces CO production. The co-production of CH₄ may also reduce catalyst life-time by coke formation and deposition thereof. A drawback of the process for syngas production disclosed in U.S. 2003/0113244A1 can lie in the selectivity of the catalyst employed; that is CH₄ formation from CO₂ is still observed as a side-reaction. In the illustrative example, this CH₄ formation was quantified as 0.8 vol % of CH₄ being formed in the gas output of the reactor, at a degree of conversion of CO₂ of 40%.

In addition, U.S. Patent Publication Nos.: 2010/0190874 and 2010/0150466 disclose processes of making syngas including CO, CO₂, and H₂ under an isothermal conditions by contacting a gaseous feed mixture including CO₂ and H₂ with a catalyst including Mn oxide and an auxiliary metals, e.g., La, W, etc.

There remains a need in the art for improved and less costly processes for making syngas from CO₂ and H₂.

### SUMMARY

The presently disclosed subject matter provides processes of making a syngas mixture including hydrogen and carbon monoxide. In one embodiment, the processes include contacting a gaseous feed mixture that includes carbon dioxide, hydrogen and methane with a metal oxide catalyst including molybdenum and nickel. The processes can be carried out at a temperature of about 600° C. to about 800° C. In certain embodiment, the syngas mixture can further include methane and carbon dioxide. The metal oxide catalyst can further include a support material. The support material can be selected from the group consisting of aluminum oxide, magnesium oxide, lanthanum oxide, and silica.

In certain embodiments, the syngas mixture has a stoichiometric number of about 1.0 to about 3.0. The carbon dioxide, methane and hydrogen can be present in the gaseous feed mixture in a ratio of about 1.0:1.0:2.0.

In some embodiments, the process of the presently disclosed subject matter is carried out at a temperature of about 720° C. The process can be carried out at atmospheric pressure. The contact time for contacting the gaseous feed mixture with the catalyst can be about 0.5 seconds to about 7.5 seconds.

The presently disclosed subject matter also provides catalysts for making a syngas mixture, including molybdenum and nickel, where molybdenum is present in an amount of about 2 wt % to about 20 wt % and nickel is present in an amount of 2 wt % to about 25 wt %, based upon a total weight of the catalyst. The catalyst can further include a support, e.g., aluminum oxide.

### DETAILED DESCRIPTION

The presently disclosed subject matter provides processes and catalysts for making a syngas mixture.

### Processes for Making a Syngas Mixture

The presently discloses subject matter provides processes for making a syngas mixture including H₂ and CO. The processes include contacting a gaseous feed mixture that includes CO₂, H₂, and CH₄ with a metal oxide catalyst. The metal oxide catalyst includes at least molybdenum and nickel. In some embodiments, the processes are carried out at a temperature of about 600° C. to about 800° C. In certain embodiments, the resulting syngas mixture further includes CO₂ and CH₄.

The processes of the presently disclosed subject matter can be performed in conventional reactors and apparatuses, including, but not limited to, those used in CH₄ reforming. One of ordinary skill in the art will be able to select a suitable reactor set-up depending on specific conditions and circumstances. Suitable types of reactors include, but are not limited to, continuous fixed bed reactors. Given the high reaction temperature, and the catalytic activity of certain metals, e.g., Ni in methanation reactions, use of a material including Ni or other active metals for making reactor walls should generally be avoided. For this reason, the reactors used in connection with the processes of the presently disclosed subject matter are generally lined with inert materials, e.g., glass linings for relevant reactor parts of the reactors. In accordance with the presently disclosed subject matter, the suitable reactor material can be ceramic.

In accordance with the presently disclosed subject matter, CO₂ is selectively converted into CO by a reverse water gas shift (RWGS) reaction in the presence of a metal oxide catalyst including at least Mo and Ni. The resulting product of this CO₂ hydrogenation process is a gas mixture containing CO and water, and non-converted CO₂ and H₂, which can be represented by the following equation:

CO₂+nH₂ [symbol] CO+(n-1)H₂+H₂O

In the above equation, n may vary widely, e.g., from n=1 to n=5, to result in a syngas composition, e.g., expressed as its H₂/CO ratio or as the stoichiometric number (SN), which can consequently vary within wide limits.

The water formed in this reaction is generally removed from the product stream driving the equilibrium of the reaction in the desired direction, because water often interferes with subsequent reactions utilizing the syngas. Water can be removed from the product stream with any suitable method known in the art, e.g., condensation, liquid/gas separation, etc.

The addition of CH₄ to the CO₂ hydrogenation process can be represented by the following total equation:

CO₂+2H₂+CH₄→2CO+4H₂. (1)

The equation (1) includes two separate parallel equations:

CO₂+H₂→CO+H₂O (2)

CH₄+CO₂→2CO+2H₂ (3)

CH₄+H₂O→CO+3H₂ (4)

The reaction (3) in the presence of nickel-containing catalysts can lead to formation of coke fragments. Addition of H₂ to the mixture of CH₄ and CO₂ can eliminate formation of coke fragments. Formation of coke fragments in methane dry reforming reaction results from decomposition of CH₄:

CH₄ [symbol] C+2H₂ (5)

Formation of coke is reversible reaction, as shown in (5), and thus, addition of H₂ in the reaction medium can reduces formation of coke fragments. On the other hand, addition of CH₄ to the mixture of H₂ and CO₂ (e.g., at least partially replacing H₂ with CH₄) can reduce the usage of H₂ that is usually costly.

One of the most serious problems encountered with conventional CO₂ reforming (also known as “dry reforming) is the deposition of carbon materials on the catalyst. Such carbon deposition causes catalyst deterioration and coking, and leads to serious operational problems in that catalyst activity is reduced and that clogging of catalyst layer and the process equipment occurs. The process of the presently disclosed subject matter, which mixes H₂ with CH₄ and CO₂, reduces or avoids coke fragment formation and/or catalyst deterioration or deactivation.

One advantage of the presently disclosed process is that the syngas mixture product may be adjusted and controlled to match desired end-use requirements. In certain embodiments, the SN value or H₂:CO ratio of the produced syngas mixture is about 1.0 to about 3.0, e.g., about 1.0 to about 2.6, or about 1.3 to about 2.6, about 1.0 to about 2.0, and about 2.0 to about 3.0. In some embodiment, the SN value or H₂:CO ratio of the produced syngas mixture is about 1.0, about 1.3, about 1.8, about 1.9, about 2.0, about 2.2, about 2.3, about 2.4, about 2.5 or about 2.6. The syngas product streams may be further employed as feedstock in different syngas conversion processes, including, but not limited to, synthesis of alkanes (e.g., ethane), synthesis of propane and iso-butane, synthesis of aldehydes, synthesis of ethers (e.g., dimethylether), synthesis of alcohols (e.g., methanol), synthesis of olefin (e.g., via Fischer-Tropsch catalysis), aromatics production, reduction of iron oxide in steel production, oxosynthesis, (hydro)carbonylation reactions (e.g., carbonylation of methanol, carbonylation of olefins), etc. For example, a syngas product with a SN value or H₂:CO ratio of about 2 can be advantageously used in olefin or methanol synthesis processes. To make olefin or methanol from the syngas mixture produced by the processes of the presently disclosed subject matter, any suitable synthesis process as known in the art can be applied.

The process of the presently disclosed subject matter exhibits a high conversion rate of CO₂ and CH₄. In certain embodiments, about 40% to about 80% (e.g., about 40% to about 50%, about 50% to about 60%, about 60% to about 70%, or about 70% to about 80%) of CH₄, from about 60% to about 90% (e.g., about 60% to about 70%, about 70% to about 80%, or about 80% to about 90%) of CO₂ in the gaseous feed mixture is converted to CO and H₂. In some embodiments, about 49% to about 78% or about 54% to about 78%, i.e., about 49%, about 52%, about 54%, about 53%, about 57%, about 58%, about 60%, about 69%, or about 78% of CH₄ in the gaseous feed mixture is converted. In other embodiments, about 64% to about 86% or about 74% to about 86%, i.e., about 64%, about 73%, about 74%, about 75%, about 77%, about 79%, or about 86% of CO₂ in the gaseous feed mixture is converted. Given the high conversion rate of CO₂ and CH₄ of the presently disclosed processes, one advantage of the presently disclosed processes is that the produced syngas mixture can be applied to various syngas conversion processes without the need to separate CO₂ and CH₄.

In certain embodiments, the gaseous feed mixture includes equal volume of CO₂ and CH₄. The volume of H₂ can be equal to the volume of CO₂ and CH₄. Alternatively or additionally, the volume of H₂ is higher than that of CO₂ and CH₄, e.g., the volume of H₂ is about twice the volume of CO₂ and CH₄, because excess H₂ in the gaseous feed mixture can prevent or avoid coke formation and improves catalyst stability. In one embodiment, the volume ratio of CO₂:CH₄:H₂ in the gaseous feed mixture is about 1.0:1.0:1.8. In one embodiment, the volume ratio of CO₂:CH₄:H₂ in the gaseous feed mixture is about 1.0:1.0:1.9. In another embodiment, the volume ratio of CO₂:CH₄:H₂ in the gaseous feed mixture is about 1.0:1.0:2.0. In accordance with the presently disclosed subject matter, the ratio of CO₂:CH₄:H₂ can be used for preparation of syngas composition. The ratio of CO₂:CH₄:H₂ can vary depending on the desired composition of the produced syngas. In one embodiment, the ratios of CO₂:CH₄:H₂ are adjusted to produce a syngas having a SN value of about 2.

The H₂ in the gaseous feed mixture used in the processes of the presently disclosed subject matter can originate from various sources, including streams coming from other chemical process, e.g., ethane cracking, methanol synthesis, or conversion of CH₄ to aromatics.

The CO₂ in the gaseous feed mixture used in the processes of the presently disclosed subject matter can originate from various sources. In certain embodiments, the CO₂ comes from a waste gas stream, e.g., from a plant on the same site, e.g., from ammonia synthesis, optionally with (non-catalytic) adjustment of the gas composition, or after recovering CO₂ from a gas stream. Recycling such CO₂ as starting material in the processes of the presently disclosed subject matter thus contributes to reducing the amount of CO₂ emitted to the atmosphere (from a chemical production site). The CO₂ used as feed may also at least partly have been removed from the effluent gas of the process itself and recycled back to the reactor in the feed mixture.

The gaseous feed mixture of the presently disclosed subject matter can further include other gases that do not negatively affect the reaction. Examples of such other gases include steam, CO and ethane.

In accordance with the presently disclosed subject matter, the process can be carried out over a wide temperature range. A high temperature can promote conversion of at least CO₂, while too high temperature can induce unwanted reactions. In certain embodiments, the process is carried out in a temperature of about 600° C. to about 800° C., e.g., about 600° C. to about 650° C., about 650° C. to about 700° C., about 700° C. to about 750° C., or about 750° C. to about 800° C. In one embodiment, the process is carried out in a temperature of about 720° C. In another embodiment, the process is carried out in a temperature of about 700° C.

The process of the presently disclosed subject matter can be performed over a wide pressure range. CO₂ hydrogenation (as shown in equation (2) above) does not change gas volume, and thus, pressure generally has no effect on the thermodynamics of the reaction (equilibrium yield). Methane dry reforming (as shown in equation (2) above) proceeds with increased gas volume, and thus, high pressure is generally not required for this reaction. Additionally, high pressure can increase the effect of reactor wall on a reaction. For example, if the reactor material includes nickel, high pressure can have negative effect on the reaction due to the coke formation on the reactor wall. The process of the presently disclosed subject matter can be performed at an atmospheric pressure. In order to overcome pressure drop, in some embodiments, the process can be performed at about 10 psig above the atmospheric pressure. In some embodiments, the process is carried out at a pressure of from about 1 atm to about 30 atm.

The contact time for contacting the gaseous feed mixture including CH₄, CO₂ and H₂ with a metal oxide catalyst including at least Mo and Ni can vary widely, but is generally about 0.5 second to about 7.5 seconds, about 1 second to about 5 seconds, about 2 seconds to about 4 seconds, or about 2 seconds to about 3 seconds.

### Catalyst

The catalyst used in the processes of the presently disclosed subject matter is a metal oxide. In accordance with the presently disclosed subject matter, the metal oxide catalyst includes at least molybdenum oxide and nickel oxide. Suitable forms of molybdenum oxide present in the catalyst include MoO₂, MoO₃. Suitable forms of nickel present in the catalyst include metallic Ni and NiO. A certain minimum content is needed to reach a desired level of catalyst activity, while a high content can increase the chance of particle (active site) agglomeration, and reduce efficiency of the catalyst. In certain embodiments, the Mo content in the catalyst (elemental Mo) is about 2 wt % to about 20 wt %, e.g., about 5 wt % to about 15 wt %, about 5 wt % to about 12 wt %, about 10 wt % to about 15 wt %, about 7 wt % to about 17 wt %, or about 8 wt % to about 12 wt %. In one embodiment, the Mo content in the catalyst is about 10 wt %. In certain embodiments, the Ni content in the catalyst (elemental Ni) is about 2 wt % to about 25 wt %, e.g., about 2 wt % to about 10 wt %, about 2 wt % to about 3 wt %, about 3 wt % to about 4 wt %, about 4 wt % to about 6 wt %, about 5 wt % to about 6 wt %, about 6 wt % to about 8 wt %, about 8 wt % to about 25 wt %, about 10 wt % to about 20 wt %, about 10 wt % to about 12 wt %, or about 12 wt % to about 15 wt %. In one embodiment, the Ni content in the catalyst is about 5 wt %. The weight percent is based upon a total weight of the catalyst, including any support material(s).

The catalyst of the presently disclosed subject matter is stable for coke formation in H₂-assisted methane dry reforming reaction because the oxidation state of Mo leads to the oxidation of coke fragments.

The catalyst used in the processes according to the presently disclosed subject matter can be applied in the form of mixed oxides or further include an inert carrier or support material or combination of carriers or support materials, of a certain particle size and geometry. In certain embodiments, the geometric form of the catalyst comprises spherical pellets, extrudates, tablets, rings, or other convenient forms.

Suitable supports can be any support materials exhibiting good stability at the reaction conditions to be applied in the process of the presently disclosed subject matter, and are known by one of ordinary skill in the art of catalysis or mixtures of support materials. In certain embodiments, the support material is at least one member selected from the group consisting of alumina, magnesia, silica, titania, zirconia and mixtures or combinations thereof. In certain embodiments, the support material is aluminum oxide.

The amount of the support material(s) present in the metal oxide catalyst used in the processes of the presently disclosed subject matter can vary within broad ranges. In certain embodiments, the amount of the support material(s) in the catalyst is about 10 wt % to about 90 wt %, e.g., about 20 wt % to about 80 wt %, or about 70 wt % to about 80 wt % (based on total weight of catalyst composition).

The catalysts used in the processes of the presently disclosed subject matter can be prepared by any conventional catalyst synthesis method as known in the art. Generally such process includes making aqueous solutions of the desired metal components, for example, from their nitrate or other soluble salt; mixing the solutions optionally with a support material; forming a solid catalyst precursor by precipitation (or impregnation) followed by removing water and drying; and then calcining the precursor composition by a thermal treatment in the presence of oxygen. The catalyst used in the presently disclosed processes can be prepared by co-precipitation of a Mo source, a Ni source and a support source.

### EXAMPLES

The following examples are merely illustrative of the presently disclosed subject matter and they should not be considered as limiting the scope of the presently disclosed subject matter in any way.

### Example 1

A glass tube filled with about 3 milliliters (ml) Mo—Ni catalyst including about 10% Mo and about 5% Ni on Al₂O₃ was applied to a fixed bed type quartz reactor. A gaseous feed mixture was made by mixing CO₂, CH₄ and H₂, and was passed through the reactor tube with an inlet flow rate of 61.1 ml/min. The gaseous feed mixture included about 25.7 vol % CH₄, about 25.2 vol % CO₂, and about 48.9 volume percent (vol %) H₂. The gaseous feed mixture was contacted with the Mo—Ni catalyst at about 690° C., about 700° C., and about 720° C. for to produce a syngas mixture. The total flow rate of the gas mixture was 50 cubic centimeters per minute (cc/min) and the contact time of a gas with the catalyst was about 3.6 seconds. The reaction was performed at atmospheric pressure. The composition of the resulting syngas mixture product was measured by gas chromatography, after removing water from the mixture in a cold trap. Table 1 shows the resulting syngas mixture composition measured after about 24 hours of reaction at each temperature.

TABLE 1

| | |
|---|---|
| Temperature | Syngas Gas Composition (volume %) |

| (° C.) | CO | H₂ | CH₄ | CO₂ |
|---|---|---|---|---|
| 690 | 25.2 | 55.8 | 13.1 | 5.8 |
| 700 | 24.9 | 59.0 | 10.8 | 5.2 |
| 720 | 26.6 | 61.9 | 7.9 | 3.5 |

The results presented in Table 1 show that the conversion rates of CH₄ and CO₂ were high. For example, about 49%, about 58%, and about 69% of CH₄ was converted at about 690° C., about 700° C., and about 720° C., respectively. About 77%, about 79% and about 86% of CO₂ was converted at about 690° C., about 700° C., and about 720° C., respectively.

### Example 2

The gaseous feed mixture included about 26.6 vol % CH₄, about 26.4 vol % CO₂, and about 46.9 vol % H₂. The gaseous feed mixture was contacted with the Mo—Ni catalyst of Example 1 at about 720° C. to produce a syngas mixture. Otherwise, the experiment was performed analogously to Example 1. Table 2 shows the resulting syngas mixture composition measured after a 2-day reaction and a 13-day reaction.

TABLE 2

Syngas Gas Composition (volume %)

| Duration (days) | CO | H₂ | CH₄ | CO₂ |
|---|---|---|---|---|
| 2 | 29.8 | 56.6 | 12.4 | 5.6 |
| 13 | 24.7 | 65.4 | 5.9 | 3.8 |

The results presented in Table 2 show that the conversion rates of CH₄ and CO₂ were high. For example, about 53%, and about 78%, of CH₄ was converted after a 2-day reaction and after a 13-day reaction, respectively. About 79% and about 86% of CO₂ was converted 2-day reaction and after a 13-day reaction, respectively. Furthermore, the Mo—Ni catalyst was shown to have good stability at least for 13 days.

### Example 3

The gaseous feed mixture included about 26.6 vol % CH₄, about 26.4 vol % CO₂, and about 46.9 vol % H₂. The gaseous feed mixture was contacted with the Mo—Ni catalyst of Example 1 at about 720° C. to produce a syngas mixture. Otherwise, the experiment was performed analogously to Example 1. Table 3 shows the resulting syngas mixture composition measured after a 2-day, a 4-day, a 8-day and a 29-day reaction.

TABLE 3

Syngas Gas Composition (volume %)

| Duration (days) | CO | H₂ | CH₄ | CO₂ |
|---|---|---|---|---|
| 2 | 27.4 | 53.5 | 12.2 | 6.85 |
| 4 | 29.8 | 52.7 | 10.6 | 6.7 |
| 8 | 33.7 | 43.8 | 12.7 | 9.6 |
| 29 | 39.2 | 42.1 | 11.4 | 7.2 |

Set forth below are some embodiments of the method and catalyst disclosed herein.

Embodiment 1: A process of making a syngas mixture comprising hydrogen and carbon monoxide, comprising: contacting a gaseous feed mixture that comprises carbon dioxide, hydrogen, and methane with a metal oxide catalyst comprising molybdenum and nickel.

Embodiment 2: A process of making a syngas mixture comprising hydrogen and carbon monoxide, comprising: contacting a gaseous feed mixture that comprises carbon dioxide, hydrogen, and methane with a metal oxide catalyst comprising molybdenum and nickel; reacting the gaseous feed mixture to form the syngas.

Embodiment 3: The process of any of Embodiments 1-2, wherein the metal oxide catalyst further comprises a support material.

Embodiment 4: The process of Embodiment 3, wherein the support material is selected from the group consisting of aluminum oxide, magnesium oxide, lanthanum oxide, silica, and combinations comprising at least one of the foregoing; preferably, wherein the support material is selected from the group consisting of aluminum oxide, magnesium oxide, lanthanum oxide, and silica; preferably, wherein the support material is selected from the group consisting of magnesium oxide and lanthanum oxide.

Embodiment 5: The process of any of Embodiments 1-4, wherein the syngas mixture further comprises methane and carbon dioxide.

Embodiment 6: The process of any of Embodiments 1-5, wherein the syngas mixture has a stoichiometric number of about 1.0 to about 3.0; preferably 1.5 to 2.5.

Embodiment 7: The process of any of Embodiments 1-6, wherein the carbon dioxide, methane, and hydrogen and are present in the gaseous feed mixture in a ratio of about 1.0:1.0:2.0.

Embodiment 8: The process of any of Embodiments 1-7, wherein the process is carried out at a temperature of about 720° C.

Embodiment 9: The process of any of Embodiments 1-8, wherein the process is carried out at atmospheric pressure.

Embodiment 10: The process of any of Embodiments 1-9, wherein the contact time for contacting the gaseous feed mixture with the catalyst is about 0.5 seconds to about 7.5 seconds; preferably 1 second to 5 seconds.

Embodiment 11: The process of any of Embodiments 1-10, wherein the process is carried out at a temperature of about 600° C. to about 800° C.

Embodiment 12: A catalyst for making a syngas mixture, comprising molybdenum and nickel, wherein the molybdenum is present in an amount of about 2 wt % to about 20 wt % and the nickel is present in an amount of about 2 wt % to about 25 wt %, based upon a total weight of the catalyst.

Embodiment 13: The catalyst of Embodiment 12, wherein the catalyst further comprises a support.

Embodiment 14: The catalyst of Embodiment 13, wherein the support material is selected from the group consisting of aluminum oxide, magnesium oxide, lanthanum oxide, and silica.

Although the presently disclosed subject matter and its advantages have been described in detail, it should be understood that various changes, substitutions and alterations can be made herein without departing from the spirit and scope of the presently disclosed subject matter as defined by the appended claims. Moreover, the scope of the presently disclosed subject matter is not intended to be limited to the particular embodiments described in the specification. Accordingly, the appended claims are intended to include within their scope such modifications. All publications, patents and patent applications cited herein are hereby expressly incorporated by reference for all purposes to the same extent as if each was so individually denoted. The term “about” or “substantially” means within an acceptable error range for the particular value as determined by one of ordinary skill in the art, which will depend in part on how the value is measured or determined, i.e., the limitations of the measurement system. For example, “about” can mean a range of up to 20%, up to 10%, up to 5%, and or up to 1% of a given value.

I/We claim:

1. A process of making a syngas mixture comprising hydrogen and carbon monoxide, comprising: contacting a gaseous feed mixture that comprises carbon dioxide, hydrogen, and methane with a metal oxide catalyst comprising molybdenum and nickel to produce the syngas mixture.

2. The process of claim 1, wherein the process is carried out at a temperature of about 600° C. to about 800° C.

3. The process of claim 1, wherein the metal oxide catalyst further comprises a support material.

4. The process of claim 3, wherein the support material is selected from the group consisting of aluminum oxide, magnesium oxide, lanthanum oxide, and silica.

5. The process of claim 1, wherein the syngas mixture further comprises methane and carbon dioxide.

6. The process of claim 1, wherein the syngas mixture has a stoichiometric number of about 1.0 to about 3.0.

7. The process of claim 1, wherein the carbon dioxide, methane, and hydrogen and are present in the gaseous feed mixture in a ratio of about 1.0:1.0:2.0.

8. The process of claim 1, wherein the process is carried out at a temperature of about 720° C.

9. The process of claim 1, wherein the process is carried out at atmospheric pressure.

10. The process of claim 1, wherein the contact time for contacting the gaseous feed mixture with the catalyst is about 0.5 seconds to about 7.5 seconds.

11. A catalyst for making a syngas mixture, comprising molybdenum and nickel, wherein the molybdenum is present in an amount of about 2 wt % to about 20 wt % and the nickel is present in an amount of about 2 wt % to about 25 wt %, based upon a total weight of the catalyst.

12. The catalyst of claim 11, wherein the catalyst further comprises a support.

13. The catalyst of claim 12, wherein the support material is selected from the group consisting of aluminum oxide, magnesium oxide, lanthanum oxide, and silica.

14. The process of claim 1, wherein the nickel is present in an amount of 12 wt % to about 15 wt %, based upon a total weight of the catalyst.

15. A process of making a syngas mixture comprising hydrogen and carbon monoxide, comprising: contacting a gaseous feed mixture that comprises carbon dioxide, hydrogen, and methane with a metal oxide catalyst to produce the syngas mixture;
wherein the process is carried out at a temperature of about 600° C. to about 800° C.; and
wherein the metal oxide catalyst comprises molybdenum in an amount of about 2 wt % to about 20 wt % and nickel in an amount of about 2 wt % to about 25 wt %, based upon a total weight of the metal oxide catalyst.

16. The process of claim 15, wherein the process is carried out at atmospheric pressure.

17. The process of claim 16, wherein the contact time for contacting the gaseous feed mixture with the catalyst is about 0.5 seconds to about 7.5 seconds.

18. The process of claim 15, wherein the contact time for contacting the gaseous feed mixture with the catalyst is about 0.5 seconds to about 7.5 seconds.
